(19) United States
(12) Patent Application Publication
(10) Pub. No.: US 2005/0015345 A1
(43) Pub. Date: Jan. 20, 2005

(54) One kind of fund flow authentication security trade system

(76) Inventors: Chong Yu Yao, Taichung City (TW); Ji Ze Li, Taichung City (TW)

Correspondence Address: Yao, Chong Yu, P.O. Box 63-150, Taichung City, 406, TW

(21) Appl. No.: 10/633,395

(22) Filed: Jul. 31, 2003

(30) Foreign Application Priority Data
Jul. 14, 2003 (TW) 092119121

(51) Int. Cl. G06F 17/60

(52) U.S. Cl. 705/64

(57) ABSTRACT

The invention is related to a kind of security trade system of fund flow authentication, which is to make the trade flow of the customer(the payer) and the shop(the payee) to be a “two-step shopping mode to promote the security and versatility of fund flow trade; it includes one separate fund flow authentication center to be convenient for the customer and the shop to apply the establishment of authentication and management service; said fund flow authentication center also needs to constitute an information connected authentication system respectively with the credit extension bank of said customer and the credit card association center to provide the data link required by the process of fund flow trade; said customer and said shop also need to have a transmission device respectively to receive and send the trade data by the online of said fund flow authentication center with Internet etc.; for the starting of the consumption, said shop firstly transmits the amount of money of credit extension of said customer through Internet to the fund flow authentication center for confirmation, and an authorization password of fund flow authentication generated by the computer processing in the fund flow authentication center will be displayed on the transmission device of said customer, then said customer transmits the authorization password of fund flow authentication to said shop for confirmation, and the credit extension bank allocate the fund according to the agreement to make the security trade of fund flow completed.

### BACKGROUND OF THE INVENTION

1) Field of the Invention

This invention is related to financial electronic trade system, more specifically, which especially refers to one kind of fund flow authentication security trade system. It can greatly promote the security and service of the trade fund flow and replace the current one-step shopping mode financial electronic trade system.

2) Description of the Prior Art

The financial electronic trade system we learned before is shown in FIG. 1, which mainly includes the single direction trade flow among customer, shop and credit card issuer bank; when the customer goes to the shop with the card or carries on trade online, the only preventive measure adopted by the shop is to confirm the identity of the cardholder at first, and then acquire the authorization password of the issuer bank through telephone, after this the trade is finished; this kind of trade flow mechanism is what is called “one-step shopping mode”.

During trading process, the shop is either fail to care for verifying the identity of the customer or it is really difficult for it to do so (especially those remote online trade of e-commerce), so it often occurs that the issuer bank refuses payment after the trade being finished; in recent years, the trade market is deluged with the forged credit cards. In the market there are no lack of criminal syndicates, illegal shops or unworthy financial institutions, they either collude with each other, or steal card number for themselves and fabricate forged card to pursue private interests or appropriate the money in the cards; so it often results in great loss of the shop, while during this kind of trade process, the only preventive measure adopted by the issuer bank is to inquire the customer whether him/her has consumed the money through telephone voice by the customer service personnel, however these are all the after inform, which is no useful for the trade security; so whether the credit card is lost or the card number is stolen by others, the assumption of the loss will often result in the disputation among the customer, shop and bank, or even they will engage in a lawsuit, and this kinds of things really emerge in endlessly.

The reason is that the current “one-step shopping mode” financial electronic trade system is a wrong method at all, because any warrant could be forged, even the anti-counterfeiting IC credit card with the current best design quality. When the credit card is stolen by others, it still will be allocated by them, so the trade mechanism only basing on the trade warrant is not reliable, which is easy to result in financial loss; additionally, the trade method that always depends on credit card or financial card in the past will also lead the fund flow trade mechanism to limit to the thin credit card consumption market space.

For the reason herein, the inventor of the system continuously studies the bottle-neck and deficiency of current one-step shopping mode financial electronic trade system in order to promote the security, wide sense and wide service of the fund flow trade mechanism, and eventually a practical invent with high use value is acquired.

### SUMMARY OF THE INVENTION

The key purpose of this invention is to provide a kind of fund flow authentication security trade system. This system adopts two-step shopping mode. It directly transmits the authorization password of fund flow authentication produced through random combination to the customer (the payer) for confirmation, and then the customer feeds back the information to the shop (the payee) for reconfirmation. After two times of confirmation, the trade is finished, which could realize the consumption fund flow mechanism with highest security.

Again, another purpose of this invention is to provide a kind of fund flow authentication security trade system, which can provide the largest prevention for the credit extension bank, the customer and the shop in the fund flow market with the combination function of authorization password for combined fund flow authentication.

Again, the third purpose of this invention is to provide a kind of fund flow authentication security trade system, which trade does not have to limit to the credit trade mechanism and will be finished by itself only after confirming the consumption identity credit, so as to result in more and more users of the fund flow trade system.

Therefore, a kind of fund flow authentication security trade system according to this invention includes at least one separate fund flow authentication center, which needs to construct one electronic database with protective device in order to provide the customer (the payer) and the shop (the payee) with the management service applied by them. The database is also configured with the system program for the computer to handle the separate operation, thus the random number coding of the program produces a group of unique authorization password for fund flow authentication at random to transmit to the customer (the payer) in order to carry on the trade; this fund flow authentication center also needs to link with the credit extension bank of the customer (the payer) and the credit card association center to become one information connected authentication system in order to provide the data communication needed by the fund flow trade process; the customer (the payer) and the shop (the payee) also need to prepare at least one transmission device that can receive and send message respectively. This transmission device is capable to transmit trade data to the fund flow authentication center through Internet (or wire and wireless route).

Construct one kind of “two-step shopping mode” trade flow depending on the above-mentioned Internet, whose flow starts with the consumption of the customer (the payer) in the shop (the payee). Firstly, the shop (the payee) transmits the credit amount of the customer (the payer) to the fund flow authentication center for confirmation through Internet (or wire and wireless route), and the authorization password of fund flow authentication produced by the computer of the center is immediately transmitted and appeared in the transmission device of the customer (the payer), and then the customer transmits (the payer) the authorization password of fund flow authentication to the shop (the payee) for confirmation, finally the credit extension bank immediately approves and allocates the funds according to the agreement to finish the trade.

### BRIEF DESCRIPTION OF THE DRAWINGS

FIG. 1 is a flow chart for the conventional electrical financial trade system.

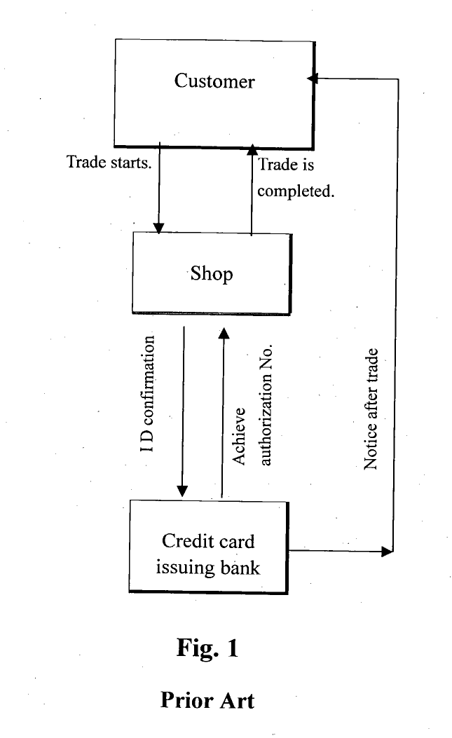

FIG. 2 is a block diagram of this invention for the security trade system of fund flow authentication.

FIG. 3 is a block diagram of this invention for the system authentication operation.

FIG. 4 is a schematic diagram of this invention for the two-step shopping operation flow.

FIG. 5 is a schematic diagram of this invention for the operation of two-step password combination.

FIG. 6 is a flow chart of this invention for the rescue mechanism of the trade without free will.

FIG. 7 is a flow chart of this invention for the temporary credit extension mechanism.

BRIEF EXPLANATION FOR FIGURE NUMBER

| | |
|---|---|
| The customer (or the payer) (1) | The shop (or the payee) (2) |
| Transmission device (1A) | Transmission device (2A) |
| Internet (3) | Fund flow authentication center (4) |
| Computer processing (4A) | Authorization password of fund |
| Credit extension bank (5) | flow authentication (A) |
| Functional password combination (7) | Credit card association center (6) |
| | Military unit and police force (8) |

### DESCRIPTION OF THE PREFERRED EMBODIMENT

Now present one preferred embodiment combined with the chart explanation in order to make your examination committee to understand the purpose, features and functional advantages of the invention in more detail:

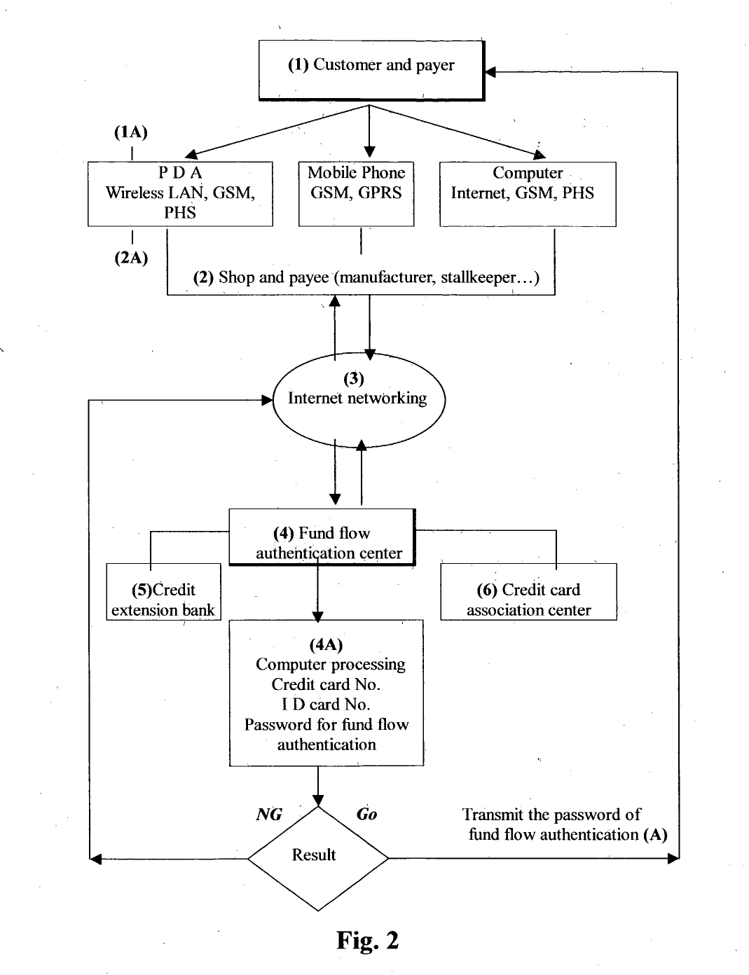

Firstly see FIG. 2, the invention-one kind of fund flow authentication security trade system mainly constructs one kind of ‘two-step shopping mode’ fund flow trade mechanism between the trade of the customer (the payer)(1) and the shop (or the payee) (3) and one separate fund flow authentication center, (4) each credit extension bank and (5) credit card association center through (2) Internet (or wire or wireless route) in order to promote the security and multifunction of the fund flow trade; of which

This fund flow authentication center (4) needs to set up one electronic database with one protective device in order to provide the management service applied by the customer (the payer) (1) and the shop (the payee). The database is also configured with the system program for the computer to handle (4A) the separate operation, thus the random number coding of the program produces a set of unique authorization password if fund flow authentication (A) at random to transmit to the customer (the payer) (1) in order to carry on the trade; again, the optimal bit number of the authorization password of fund flow authentication is 16˜18.

This fund flow authentication center (4) also needs to link with the credit extension bank (5) of the customer (the payer) and the credit card association center (6) to become one information connected authentication system in order to provide the data communication needed by the fund flow trade process.

The customer (the payer) (1) and the shop (the payee) (2) also need to prepare at least one set of transmission device (1A) (2A) that can receive and send message respectively. This transmission device (1A) (2A) can transmit trade data to the fund flow authentication center (4) through Internet (or wire and wireless router); of which, the transmission device (1A)(2A) includes PDA (wireless LAN, GSM, PHS), mobile phone (GSM, GPRS) or computer (Internet, GSM, PHS);

Construct one kind of “two-step shopping mode” trade flow depending on the above-mentioned Internet, whose flow starts with the consumption of the customer (the payer) (1) in the shop (the payee) (2). Firstly, the shop (the payee) (2) transmits the credit amount of the customer (the payer) (1) to the fund flow authentication center (4) through Internet. After being confirmed, the unique authorization password of fund flow authentication (A) produced by the computer of the center is immediately transmitted and appeared in the transmission device (1A) of the customer (the payer) (1), and then the customer transmits (the payer) (1) the authorization password of fund flow authentication (A) to the shop (the payee) (2) so as to prevent the trade process password from being stolen. Once the password having been confirmed, the trade will be finished and the credit extension bank (5) can also approve and appropriate the funds according to the agreement; therefore, this system can effectively prevent such malpractice as appropriating the credit card by adopting the two-step two-time confirmation trade mode, because the password of each trade is not fixed (the random number coding made by the computer at random), and it can finish the final trade flow only after the real identity of the user having been confirmed, so it will assure the absolute security of the whole trade mechanism.

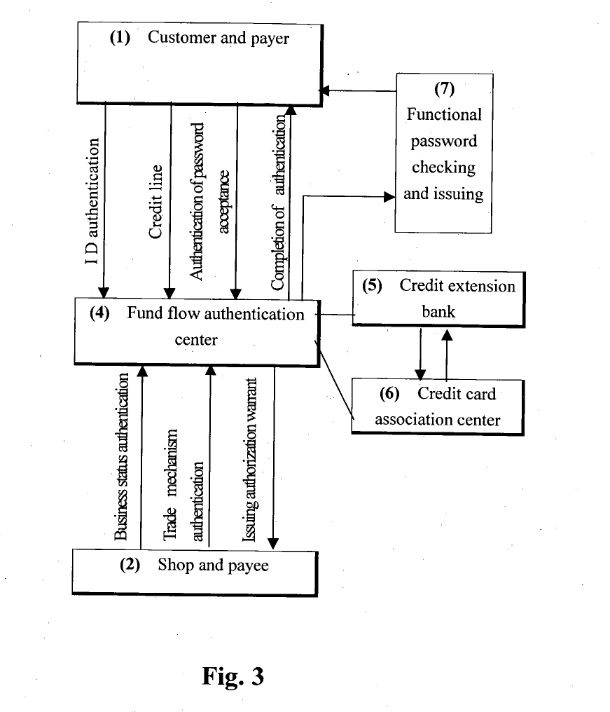

The authentication register application about the above mentioned fund flow authentication center (4) is prepared for various customers, please refer to FIG. 3. Its users include the customer (the payer) (1), the shop (the payee) (2), etc. that want to carry on trade through this fund flow system. Before using the system, they need to register the following items in the fund flow authentication center: identity authentication (individual, organization, company, industry . . . , etc.), line of credit authentication (bank deposit, financial status), password accept authentication (transmission device register), operating state authentication (operating items), trade mechanism authentication (transmission device register), etc., the data about the authentication register should be adjusted according to the operating requirement of the fund flow authentication center (4); after the user (customer) having finished the registration, the fund flow authentication center (4) will release a set of “functional password” with several function parameters to the customer (the payer) (1) for emergency and also give the shop (the payee) (2) one unique code of each trade unit, the operation about the multiple sets of “functional password” (7) of the customer (the payer) will be introduced later.

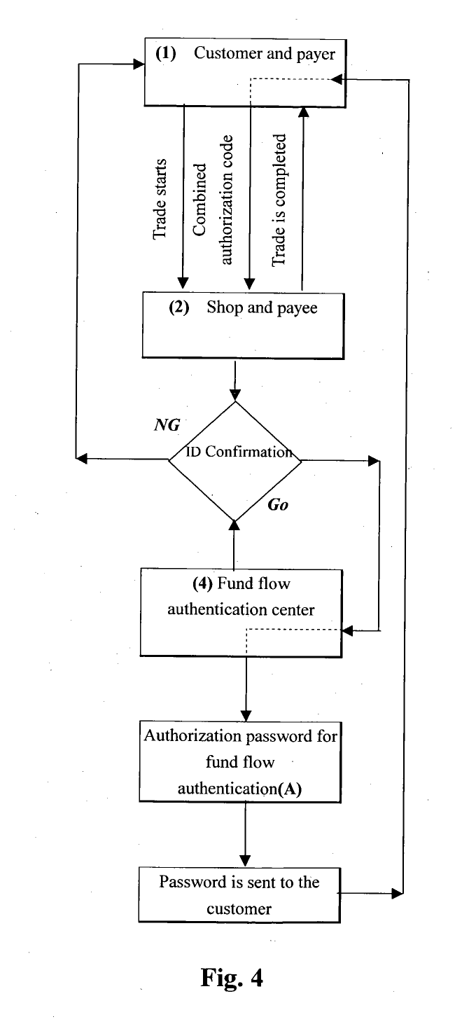

According to the above description, because the fund flow authentication center (4) has released the “functional password” with multiple sets of function parameters to the customer (the payer) (1) for emergency, this system can further choose the following operating mode with higher security. It will be described at more detail as follows combined with FIG. 4:

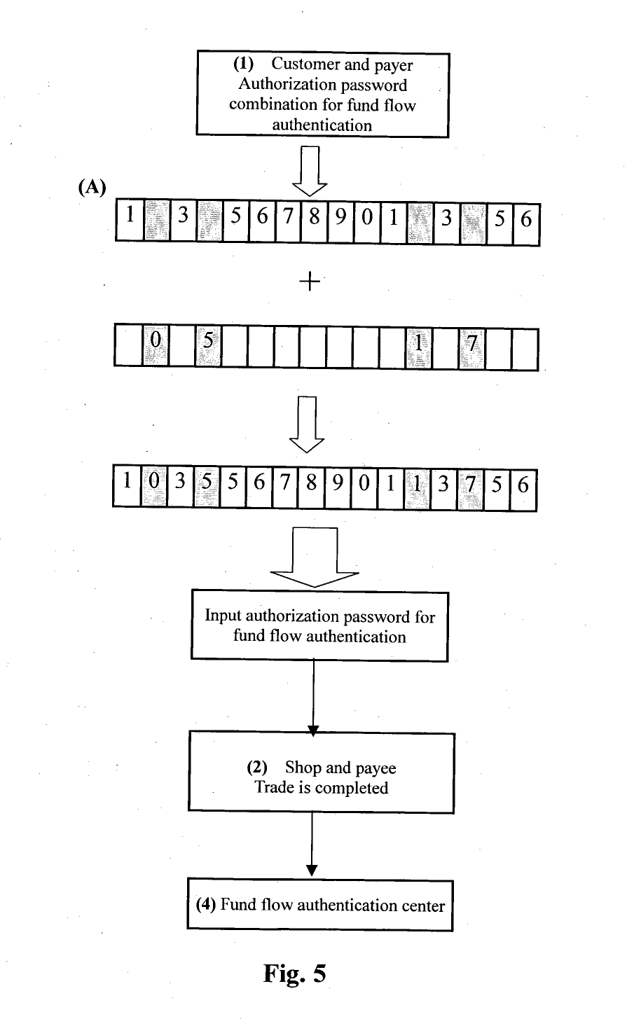

The operation of this system is also one kind of “two-step shopping mode” trade flow based on the above mentioned Internet, whose flow also starts with the consumption of the customer (the payer) (1) in the shop (the payee) (2). Firstly, the shop (the payee) (2) transmits the credit amount and the amount to be traded of the customer (the payer) (1) to the fund flow authentication center (4) through Internet (or wire and wireless route), after being confirmed, the unique 16-digit authorization password of fund flow authentication (A) with complex number blank stagger (shown in FIG. 5) produced by the computer of the center (4) is immediately transmitted and appeared in the transmission device (1A) of the customer (the payer) (1), which will become one complete set of authorization password of fund flow authentication combined with one set of functional password (7) defined by the customer (the payer) (1) himself, and then the customer (the payer) (1) transmits the combined authorization password of fund flow authentication (A) to the shop (the payee) (2) so as to prevent the trade process password from being stolen. Once the password having been confirmed, the trade will be finished, while the credit extension bank (5) will also approve and allocate the funds according to the agreement.

Therefore, this system not only adopts the same two-step two-time confirmation trade mode above mentioned, but also it will effectively prevent the credit card from being embezzled, because the password of each trade is not fixed (the password is coded by the random number of the computer program at real time), and the complete coding of the final combined authorization password of fund flow authentication (A) will only be finished with one set of parameter combination of the functional password (7) owned by the customer (the payer) (1) himself, so the main control power related to the authorization password is totally held by the customer (the payer) (1), and only after the real identity of the user having been confirmed, the final trade flow will be finished, thus there is absolutely no embezzlement to occur, and the system will really assure the absolute security of the whole trade mechanism.

The above combined authorization password for fund flow authentication (A) is composed in two steps by the customer (the payer) (1) cooperating with its preset functional password combination. Said functional password (7) is developed and preset to be a variety of parameters in said fund flow authentication center (4) to execuate special functional instructions respectively according to the setting. The operation is listed and described as follows:

Firstly, please refer to FIG. 5, wherein said customer (the payer) (1) uses the portable transmission device (1A) capable of receiving and sending information to receive the authorization password for fund flow authentication (A) from said fund flow authentication center (1A). The group of authorization password for fund flow authentication is the blank spaces of 16 digital numbers as the display of the grid in the Figure, wherein the displayed 12 digital numbers are random number coding generated by the real time operation of the system program of the authorization password for fund flow authentication (A); for example, in “1 3_{—}5678901_{—}3_{—}56” as shown in the Figure, the stagger blanks are reserved for the customer (the payer) to freely input the required functional parameters—a combination functional password with four parameters; for example, inputting “0517” as shown in the Figure, thus the complete authorization password of fund flow authentication (A) “1035567890113756” is combined by the customer (the payer) of their own accord, and the combined authorization password of fund flow authentication (a) is emitted to the shop (the payee) (2) by the portable transmission device (1A), or confirmed directly by the transmission device (2A) of the shop (the payee) (2), then the trade is completed and the bank of credit extension (5) must check and allocate the fund.

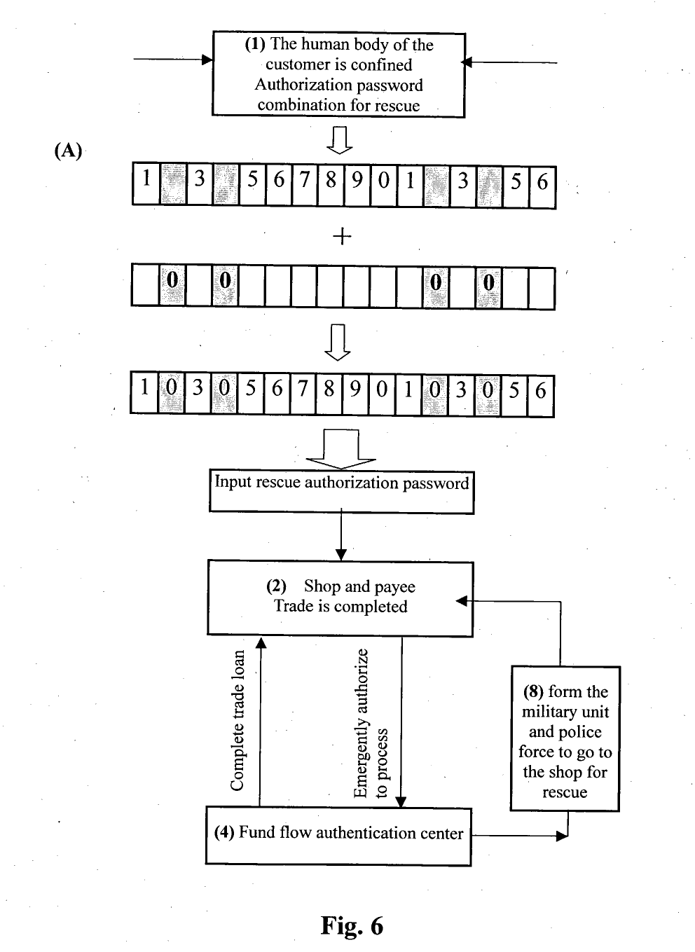

Secondly, cooperated with the reference of FIG. 6, the parameters of the above functional password combination (7) will be set to be a function of “special emergency code” according to the agreement, such as “0000” displayed in the Figure; when the customer (the payer) (1) is extorted by the bandits to consume and draw his money in the shop (the payee) (2) without free will, although the customer (the payer) will still receive a group of the authorization password for fund flow authentication (A) with 12 digital number “1_{—}3_{—}5678901_{—}3_{—}56” and four stagger “blank spaces” in the same way, the final main control power of combined coding is gripped by the customer (the payer) (1) himself, thus said customer (said payer) with the bandits unable to know collocates with the emergency parameters of “0000” to enter into the blank spaces to form a combined authorization password for fund flow authentication (A) concealed with rescue instruction “1030567890103056” of own accord. Although the fund flow authentication center (4) will allocate funds after the trade is confirmed to be completed, the fund flow authentication center (4) will immediately contact the military unit or police force (8), which is nearest to the transacted shop, to rescue as soon as possible, then the safety of the customer (the payer) will be promoted to a large extent in the trade.

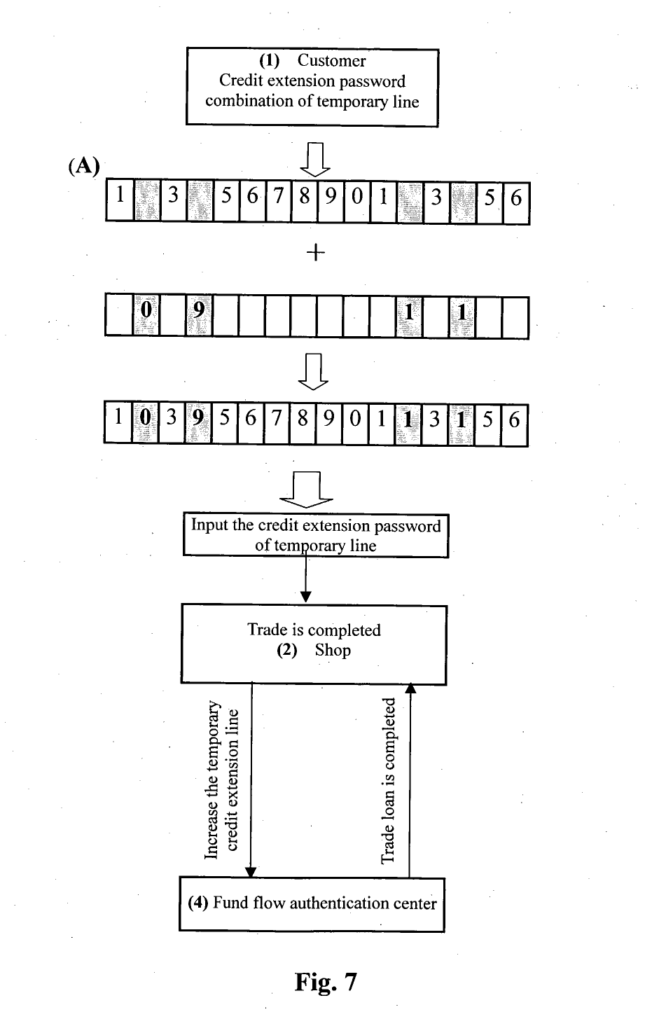

Furthermore, as shown in the FIG. 7, the parameters of the above functional password combination (7) will be set to be the function of “emergent promotion of credit extension” according to the agreement, for example “0911” displayed in the Figure; i.e. when the customer (the payer) locates some special places such as airport and dock to travel by communication facilities and finds that the credit extension is insufficient, although the customer (the payer) receives the authorization password for fund flow authentication (A) of “1_{—}3_{—}5678901_{—}3_{—}56” in the same way, a authorization password for fund flow authentication (A) of emergency credit extension instruction of “1039567890113156” will be generated after the customer (the payer) (1) inputs the parameters of the emergent promotion of credit extension of “0911”, and the fund flow authentication center (4) will still confirm and complete the trade and allocate the fund, only adding the service charge of the promotion of credit extension after the trade.

For the parameter design instance of the above listed functional password combination and the trade flow of “two-step shopping mode”, those who is used to the technology is capable to change its applications, including service parameters, instruction, combination or subdivision of the system and the simplification or complication of various operation modes and flows according to the idea of this invention and the possible design of the function, but these possible equivalent modification belongs to the design principle option of this invention; or the service center established according to the idea of the implementation of fund flow authentication center system in the present invention is included in the claims of this invention.

As mentioned above, this invention is related to a security trade system of fund flow authentication, and its innovative trade mechanism and flow will break the bottle-neck of conventional one-step shopping mode, wherein said customer (said payer) will use the authentication evidence to transact, including the numbers sufficient for the authentication of the fund flow authentication center, such as the credit card number, fiscard number, ID card number and passport number. Beyond dispute, the security trade system of fund flow authentication in this invention has wide playing space and does not restrict to credit card consumption. Furthermore, the two-step shopping mode in this invention uses nonreplaceable fund flow authentication password by random coding to confirm the trade for two times, so as to realize the most secure consumption fund flow system. With the combined fund flow authentication password of assorted functional parameters, this invention will realize the maximum guarantee function among the shop, the credit extension bank and the customer in the fund flow market. It is surely an invention patent with high utility value in accordance with the industry.

1. A kind of security trade system of fund flow authentication, including:
At least one separate fund flow authentication center is constructed with an electronic database of protection device to provide the customer (the payer) and the shop (the payee) with the capability of application of authentication management service; said electronic database has a system program for computer to separately process the operation, and an only group of authorization password fund flow authentication is generated in real time with random number coding of the program and is sent to the customer (the payer) for trade;
Said fund flow authentication center also needs to form a joint authentication system of information respectively with a credit extension bank of said customer (said payer) and a credit card association center, so as to provide the data connection required in fund flow trade process;
Said customer (said payer) and said shop (said payee) also respectively requires a set of transmission device capable receiving and sending information, which transfers the trade data by the online between Internet (or wired and wireless route) and a fund flow authentication center;
With the above Internet, a kind of “two-step shopping mode” trade flow is established, wherein the flow starts from the customer (the payer) consuming in the shop (the payee), and the shop (the payee) firstly transmits the credit amount of money of the customer (the payer) through Internet (or wired and wireless route) to said fund flow authentication center for confirmation, which generates a group of authorization password for fund flow authentication by the real time process of computer to display on said transmission device of said customer (said payer), then said customer (said payer) transmits the authorization password for fund flow authentication to said shop (said payee) for confirmation and the credit extension bank checks and allocates the fund according to the agreement to complete the security trade of fund flow.

2. A security trade system of fund flow authentication according to claim 1, wherein said authorization password for fund flow authentication is preferred to be 8 to 16 numbers.

3. A security trade system of fund flow authentication according to claim 1, wherein said transmission device between said customer and shop includes PDA (wireless LAN, GSM and PHS), mobile phone (GSM and GPRS) or computer (Internet, GSM and PHS).

4. A security trade system of fund flow authentication according to claim 1, wherein the trade will be carried out when the authentication warrant of said customer (said payer) in trade is the number sufficient for the authentication of the fund flow authentication center, such as credit card number, fiscard number, ID card number and passport number etc.

5. A security trade system of fund flow authentication, including:
At least one separate fund flow authentication center is constructed with an electronic database of protection device to provide the customer (the payer) and the shop (the payee) with the capability of application of authentication management service and the functional password of several groups of functional parameters that is sent to said customer (said payer) when putting on record; the database has a system program to process separate operation by a computer, and with a random process of the program the random number coding will generate a group of authorization password with “many space staggering” in real time to send to said customer (said payer), so as to combine the preset functional password of the own accord of said customer (said payer) into a combined authorization password for fund flow authentication required by a trade to carry out the trade;
Said fund flow authentication center needs to form an information connected authentication system respectively with the credit extension bank of said customer (said payer) and the credit card association center, so as to provide the data connection required in the process of fund flow trade;
Said customer (said payer) and said shop (said payee) also need to have at least one set of transmission device capable of receiving and sending information, which transmits trade data by the online between Internet (or wired and wireless route) and said fund flow authentication center;
With the above Internet, a kind of two-step shopping mode trade flow is established, wherein its flow starts from the customer (the payer) consuming in the shop (the payee), and said shop (said payee) firstly transmits the amount of money of credit extension to the fund flow authentication center for confirmation through Internet; after the process of computer in the fund flow authentication center, the generated authorization password immediately transmits to said customer (said payer) and displays on his transmission device, then said customer (said payer) will determine a functional password of a group of parameters of own accord to form a group of combined authorization password of fund flow authentication, and after the confirmation of said shop (said payee), the credit extension bank of the payer will check and allocate the fund according the agreement, then the security trade of fund flow is completed.

6. A security trade system of fund flow authentication according to claim 5, wherein said authorization password of fund flow authentication is preferred to be 8 to 16 numbers and the multiple staggered spaces of said authorization password are rightly filled and combined with said functional password in order.

7. A security trade system of fund flow authentication according to claim 5, wherein the trade will be carried out when the authentication warrant of said customer (said payer) in trade is the number sufficient for the authentication of the fund flow authentication center, such as credit card number, fiscard number, ID card number and passport number etc.

8. A security trade system of fund flow authentication according to claim 5, wherein said functional password is preset by the fund flow authentication center to be a parameter with special authorization service instruction, and the trade required by said customer (said payer) will be completed by assortment of said combination of authorization password for fund flow authentication.

9. A security trade system of fund flow authentication according to claim 5, wherein said functional password include a group of parameters with alarm and emergency rescue instructions preset by the fund flow authentication center, which is used to finish the trade when the customer (the payer) is held under duress, through the way that the customer service personnel of the fund flow authentication center inform the military unit and police force to quickly go up to the trade place for rescue.
